(19) United States
(12) Patent Application Publication
(10) Pub. No.: US 2019/0345674 A1
(43) Pub. Date: Nov. 14, 2019

(54) PROCESS TO PREPARE A BIODEGRADABLE PULP PRODUCT

(71) Applicant: LAND LIFE COMPANY B.V., Amsterdam (NL)

(72) Inventors: Harrie Maurice LOVENSTEIN, Amsterdam (NL); Arnout Jan ASJES, Overveen (NL); Jurriaan RUYS, Amsterdam (NL)

(73) Assignee: LAND LIFE COMPANY B.V., Amsterdam (NL)

(21) Appl. No.: 16/471,744

(22) PCT Filed: Dec. 11, 2017
(86) PCT No.: PCT/NL2017/050828

§ 371 Date: Jun. 20, 2019

(30) Foreign Application Priority Data
Dec. 22, 2016 (NL) 2018041

(51) Int. Cl. D21J 3/10; D21J 1/04; D21J 1/08; D21J 1/16; A01G 9/02

(52) U.S. Cl. CPC D21J 3/10; D21J 1/04; A01G 9/021; D21J 1/16; D21J 1/08

(57) ABSTRACT

The invention is directed to a process to prepare a three-dimensional shaped biodegradable pulp product by (b) pressing a 3D product made of biodegradable pulp which product is coated with a water-resistant compound having a melting temperature of above 40° C. in a mould at a temperature above the melting temperature of the water-resistant compound, and (c) releasing the product from the mould and reducing the temperature to below the melting temperature of the water-resistant compound.

The invention is directed to a process to prepare a water resistant three-dimensional shaped biodegradable pulp product.

WO2015/063243 describes a planting apparatus made of pulp. The planting apparatus comprises a water reservoir for a growing a plant, preferably a tree. The tree is provided with water from the reservoir via a wick. The pulp product should be able to hold the water for a certain minimum of time such that the tree can grow and its roots can penetrate the ground and become self-sustainable. After a while the pulp product will disintegrate and become part of the ground surrounding the tree. The advantage of using a pulp product is that it is easy to produce from bio-derived materials, it is light and it is biodegradable. A disadvantage is that it is water permeable. For this reason water resistant additives like a wax are added to the pulp material. WO2015/063243 refers to two earlier patent publications as examples of how wax can be added to the pulp product. In GB456434 a process is described in which Japanese wax is added to an emulsion containing cellulose chemical wood pulp fibres and casein. It was shown that the product containing the Japanese wax had a better water resistance than the pulp products as prepared without the Japanese wax. In GB276395 a process is described in which a resin is added to an emulsion containing pulp fibres. The product is cured in a mould wherein the resin chemically reacts. The resulting pulp product is described to have a better water resistance.

A problem with the pulp products as described in WO2015/063243 is that the resulting pulp product does not have the required water resistance properties which are required for a planting apparatus made of pulp as described in said patent publication. Pulp products obtained from an emulsion also containing wax did not have the required water resistance. Even if they did, the amount of wax required to prepare such a product is high. The object of the present invention is to provide a process which can prepare a pulp product with an superior water resistance and which does not have the disadvantage of the prior art products or processes.

This object is achieved with the following process.

Process to prepare a three-dimensional shaped biodegradable pulp product by

(b) pressing a 3D product made of biodegradable pulp which product is coated with a water-resistant compound having a melting temperature of above 40° C. in a mould at a temperature above the melting temperature of the water-resistant compound, and

(c) releasing the product from the mould and reducing the temperature to below the melting temperature of the water-resistant compound.

Applicants found that the pulp product obtained by this process has a better water resistance than a product wherein the water-resistant compound is added to the starting emulsion when making the pulp product. It is believed that by pressing at elevated temperatures in step (b) a better contact between the pulp fibres and the water-resistant compound is achieved which would explain the better water resistance. Further advantages of the process will be described below.

The 3D product which is coated with a water-resistant compound comprises of a starting three-dimensional shaped biodegradable pulp product and a coating of a water-resistant compound.

The starting three-dimensional shaped biodegradable pulp product may be any product made from a biodegradable lignocellulosic fibrous material. Typically such lignocellulosic fibrous material is obtained by chemically or mechanically separating the cellulose fibres from wood, waste of crops, fiber crops or waste paper, especially waste carton. Examples of fibre crops are Miscanthus spp or Guayule (Parthenium argentatum). The pulp product itself may be made by well known processes. The starting pulp product may comprise additives such as bio-repellents to protect the pulp product against insects and small mammals. Example of a suitable bio-resistant is capsaicin. Preferably these bio-repellent compounds are added to the water-resistant compounds, preferably the wax as present in the coating. In this manner they will be deposited at or close to the surface of the biodegradable pulp product which will enhance their function as resistant to insects and the like. This is especially advantageous when the biodegradable pulp product is a planting apparatus as here described.

The starting three-dimensional shaped biodegradable pulp product may be a container having a downwardly tapering wall, a closed bottom end and an open ended opposite end. The tapering wall may have any cross-sectional shape, for example square. Preferably the cross-sectional shape is circular and the container has a cup-shape. The bottom may be closed such to provide structural strength to the container. Such bottom may be provided with small openings which will not necessarily worsen the strength of the container.

In a preferred embodiment, the starting three-dimensional shaped biodegradable pulp product is a planting apparatus and more preferably a planting apparatus comprising a container comprising an annular compartment with a downwardly tapering outer wall of circular cross section and an upwardly tapering inner wall defining a central open channel through which a symmetry axis runs, wherein the annular compartment is closed at its lower end and open at its upper end. Such a container is described in the afore mentioned WO2015/063243.

The water-resistant compound has a melting point of above 40° C. and preferably below 200° C. The water-resistant compound is preferably a hydrophobic compound. Preferably the water-resistant compound is a wax. Waxes having the desired melting points are known to achieve a good water-resistance. The wax may be a petroleum or natural derived paraffin or microwax or a mixture thereof. Optionally the wax may be obtained by a Fischer-Tropsch reaction starting from hydrogen and carbon monoxide. The melting temperature of the wax may be between 60° C. and 120° C. and preferably between 70 and 120° C.

The 3D product which is coated with a water-resistant compound is suitably obtained in a step (a) in which step the water-resistant compound is sprayed on the surface of a starting three-dimensional shaped biodegradable pulp product.

In step (a) the water-resistant compound is sprayed on the surface of a starting three-dimensional shaped biodegradable pulp product. Such a product is preferably dry such that the water-resistant compound can easily adhere and even absorb into the pulp material. The amount of water-resistant compound applied per surface area of the pulp product can be easily determined by the skilled person. For a typical wax having the preferred melting properties as described above the amount of wax may be between 5 and 1000 g/m² and more preferably between 50-600 g/m². It has been found that a relation exists between the amount of water-resistant compound applied to the surface and the water resistance. By varying the water-resistant compound content pulp products may be prepared which for example have a different water breakthrough. For example if the product is used to hold water products can be prepared to hold water for about one months by using a certain amount of water resistant compound to about 12 months using more water-resistant compound. The wall of the pulp product may collapse resulting in that the water flows through said opening in the wall to its surroundings. By collapsing is here meant that the water permeability of the wetted wall increases due to amongst others the formation of micro pores.

The variation in water resistant compound may also be beneficially used in a single product. For example, the above describe planting apparatus may be produced wherein less water-resistant compound is applied on the upwardly tapering inner wall as compared to the amount applied on the downwardly tapering outer wall. This will result in that this inner wall will collapse first thereby releasing water at the centre of the planting apparatus. This is advantageous because water will then flow to the area in the ground where the roots of the plant or tree are present. Applicants even found that the water permeability of the wall may be influenced such that in use water may flow through the inner wall to the roots of the plant. This flow of water can be so regulated that the use of a wick may even be omitted. A disadvantage of using a wick is that it requires careful positioning when the planting apparatus and the plant are buried into the ground. Furthermore wicks may become contaminated with for example salts which negatively influence the capillary working of the wick. In practice it has been found that part of a group of plants as planted with this planting aid product did not grow because of an incorrect positioning of the wick. So by being able to use the product without the wick a more reliable product is obtained. A further advantage is that the root collar of the plant can now be positioned lower relative to the planting aid product. The root collar may now even be positioned at the level of the lower end of the annular compartment. This simplifies the planting procedure and avoids failures. Such positioning would be more complex or even not possible when a wick is used to transport the water to the plant.

Such a variation in water permeability between inner wall and outer wall may be achieved by a process wherein less or no water-resistant compound is sprayed on the upwardly tapering inner wall as compared to the amount of water resistant compound sprayed on the downwardly tapering outer wall in terms of the amount of wax per surface area resulting in that the upwardly tapering inner wall is more water permeable than the downwardly tapering outer wall.

Alternatively or in combination with the above process such variation may be achieved by a process wherein a different water-resistant compound is sprayed on the upwardly tapering inner wall as compared to the water-resistant compound sprayed on the downwardly tapering outer wall resulting in that the upwardly tapering inner wall is more water permeable than the downwardly tapering outer wall.

In case the starting three-dimensional shaped biodegradable pulp product is a container having a downwardly tapering wall, a closed bottom end and an open ended opposite end as described above step (a) is preferably performed as follows. The outer wall surface of the tapering wall is sprayed with the water-resistant compound and the inner surface of the tapering wall is sprayed with the water-resistant compound while the three-dimensional shaped biodegradable pulp product rotates along an axis running from the closed bottom end to the open ended opposite end. By rotating the pulp product, preferably along its symmetry axis running from the bottom to the open end, it is possible to simultaneously spray the entire product using two sources of preferably static positioned and directed spray guns.

In case the starting three-dimensional shaped biodegradable pulp product is the earlier described planting apparatus step (a) is preferably performed as follows. The outer wall surface of the outer wall, the inner wall surface of the annular compartment and the outer wall surface of the inner wall is sprayed with the water-resistant compound while the three-dimensional shaped biodegradable pulp product rotates around the symmetry axis.

Preferably the spraying of the outer wall surface of the outer wall and the inner wall surface of the annular compartment is performed before or after the spraying the outer wall surface of the inner wall. An advantage of performing these spraying actions in separate steps in time is that it simplifies an automatic spraying sequence as will be illustrated in the Figures. Furthermore, different amounts of water-resistant compound as applied to different surfaces may be different, which is beneficial as explained above.

The invention is also directed to a process to spray a water-resistant compound having a melting point of above 40° C. onto a surface of a biodegradable pulp product, wherein the product is a container comprising an annular compartment with a downwardly tapering outer wall of circular cross section and an upwardly tapering inner wall defining a central open channel through which a symmetry axis runs, wherein the annular compartment is closed at its lower end and open at its upper end and wherein the outer wall surface of the outer wall, the inner wall surface of the annular compartment and the outer wall surface of the inner wall is sprayed with the water-resistant compound while the biodegradable pulp product rotates around the symmetry axis. The referred to surfaces may be sprayed simultaneously. Preferably the spraying of the outer wall surface of the outer wall and the inner wall surface of the annular compartment is performed before or after the spraying the outer wall surface of the inner wall.

As exemplified above the surface of the starting three-dimensional shaped biodegradable pulp product may be comprised of an inner wall surface and an outer wall surface. The mould in step (b) is suitably comprised of a mould part having a surface shaped to receive the inner wall surface and a mould part having a surface shaped to receive the outer wall surface. In step (b) the 3D product is placed between the two mould parts and pressed by the two mould parts. In this step (b) the temperature will be suitably maintained at a temperature above the melting temperature of the water resistant compound by heating the mould parts.

The 3D product and coated with a water-resistant compound may also be obtained by a process step wherein a three-dimensional biodegradable pulp product is present between at least two parts of a mould and wherein the water-resistant compound is supplied as a liquid to the surface of the starting three-dimensional biodegradable pulp product via channels as present in the mould parts which channels fluidly connect a source of the liquid water-resistant compound and the surface of the starting three-dimensional biodegradable pulp product. In such a process no actual spraying will take place. By applying the water-resistant compound via channels in the mould parts no spraying is applied. This has the advantage that the wax is more efficiently used and less wax is lost as is the case when spraying. Furthermore no overspray can take place as may be the case when spraying, no air purification treatment is required, less cleaning of a spraying room is required and less energy is used. Furthermore less handling is required. Such a process is preferably performed for a biodegradable pulp product which is a container comprising an annular compartment with a downwardly tapering outer wall of circular cross section and an upwardly tapering inner wall defining a central open channel. This is the afore mentioned planting apparatus.

In the above process less or no water-resistant compound may be supplied to the surface of the upwardly tapering inner wall as compared to the amount of water resistant compound supplied to the surface of the downwardly tapering outer wall in terms of the amount of wax per surface area. This results in that the upwardly tapering inner wall is more water permeable than the downwardly tapering outer wall.

Alternatively or in combination with the above process a different water-resistant compound may be supplied to the surface of the upwardly tapering inner wall as compared to the water-resistant compound supplied to the surface of the downwardly tapering outer wall resulting in that the upwardly tapering inner wall is more water permeable than the downwardly tapering outer wall.

This process variant also enables one to make a planting apparatus which does not require a wick for the same reasons as explained before.

The pressure in step (b) as exercised on the pulp product may be between 0.1 and 5 MPa. Preferably this pressure is above 1 MPa. Preferably the pressure is not higher than 2 MPa such to protect the pulp product against damage.

The invention is also directed to a planting aid product comprising

a container comprising an annular compartment for water composed of a biodegradable pulp with a downwardly tapering outer wall and an upwardly tapering inner wall defining a central open channel, where in use a plant is positioned, wherein the annular compartment is closed at its lower end and open at its upper end,

wherein a circular lid closes the upper open end of the annular compartment and wherein the lid has a central opening which opening aligns with the central open channel of the container, and

wherein the downwardly tapering outer wall and an upwardly tapering inner wall are coated by a water-resistant compound.

Preferably the upwardly tapering inner wall is more water permeable than the downwardly tapering outer wall, wherein the downwardly tapering outer wall is coated with a water-resistant compound and the upwardly tapering inner wall may be coated with a water-resistant compound and wherein the difference in water permeability of the inner and outer wall is at least in part a result of a difference in the content, quality and/or position of the water-resistant compound as coated on the inner and outer walls. By difference in quality is meant that the compounds used have a different chemical structure. The water-resistant compound may be the same as described above for the process and preferably is a wax having a melting temperature of between 60° C. and 120° C. The wax is preferably a paraffinic wax and/or microwax. The water permeability of the upwardly tapering inner wall is at least 0.05 litre/day as measured 5 days after the annular compartment is filled water to 95% of its vertical height. Suitably no wick is present to transport water from the annular compartment to the plant in the central channel. The planting aid product is preferably obtainable by the process according to the invention.

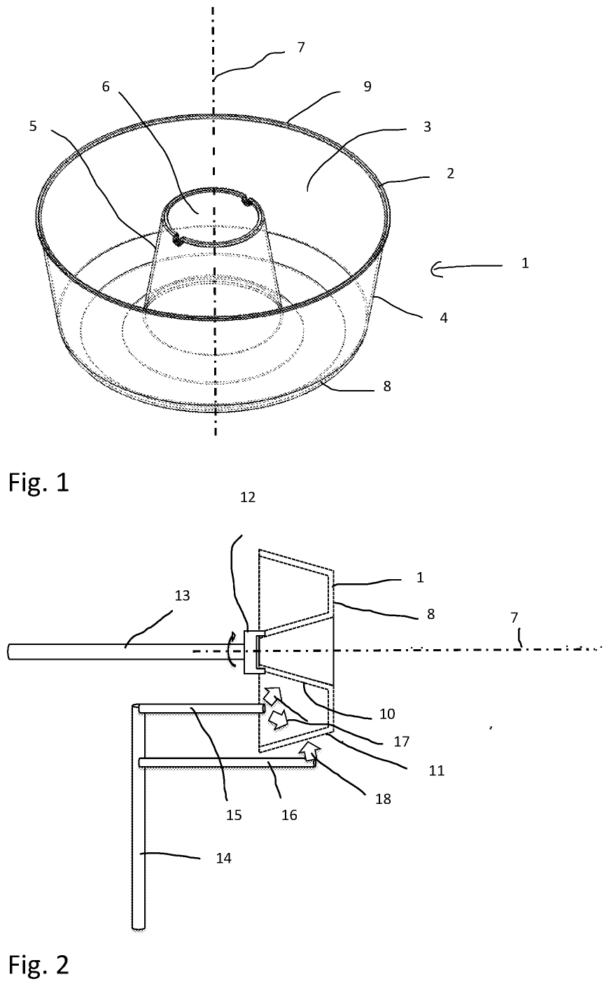

The invention will be illustrated by the following non-limiting Figures and Examples. The Figures show how the invention may be performed wherein the water-resistant compound is a wax. FIG. 1 is a starting three-dimensional shaped biodegradable pulp product (1) suited to make a planting apparatus. Shown is a container (2) comprising an annular compartment (3) for holding water. The annular compartment (3) is defined by a downwardly tapering outer wall (4) of circular cross section and an upwardly tapering inner wall (5) defining a central open channel (6) through which a symmetry axis (7) runs. The annular compartment (3) is closed at its lower end (8) and open at its upper end (9). The 3D product as obtained may be combined with a flat cover (not shown) to cover the open upper end (9) and a guiding cone (not shown) positioned in open channel (6) for guiding a plant as further described in WO2015/063243.

FIG. 2 shows how the inner walls (10) and the outer wall (11) of the annular compartment (3) of starting three-dimensional shaped biodegradable pulp product (1) of FIG. 1 is subjected to a wax spraying. The pulp product (1) is hereby fixed at with a fixing means (12) to a rotating axis (13) such that the entire product (1) rotates around the symmetry axis (7). Main supply (14) has two branches (15) and (16). These branches and also the spray guns suitably have heated mantles such to ensure that the wax remains liquid while it flows through these conduits. Branch (15) supplies wax to a spraying gun (17) which sprays wax on inner walls (10) of the annular compartment (3). Spraying gun (17) may also be a spraying module with more than one nozzle which may discharge wax at different rates. Branch (16) supplies wax to a spraying gun (18) which sprays wax on the outer wall (11) of the annular compartment (3). Because pulp product (1) rotates the spraying guns (17) and (18) can be positioned in one position with one spraying direction.

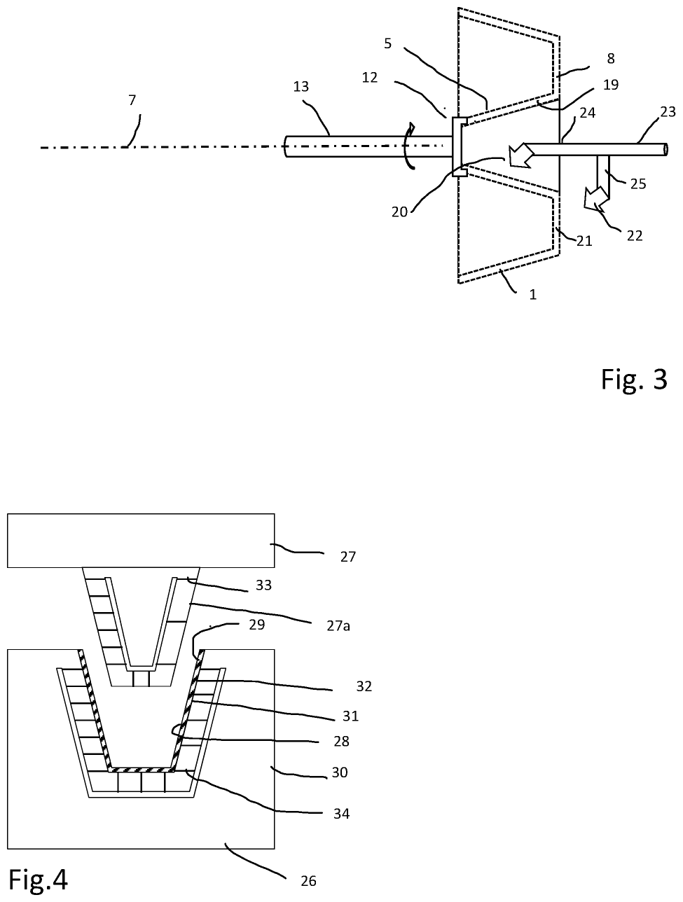

FIG. 3 shows the same pulp product (1) fixed with a fixing means (12) to a rotating axis (13). In this figure the outer wall surface (19) of the upwardly tapering inner wall (5) is sprayed using a spraying gun (20) with liquid droplets of wax while the biodegradable pulp product (1) rotates around the symmetry axis (7). The outer wall (21) of lower end (8) is sprayed by spraying gun (22). The liquid wax is supplied by main supply (23) connecting to two branches (24, 25). Branch (24) supplies wax to spraying gun (20) and branch (25) supplies wax to spraying gun (22). Because pulp product (1) rotates the spraying guns (20) and (22) can be positioned in one position with one spraying direction. Rotating axis (13) is preferably the same as in FIG. 2. In fact the spraying illustrated in FIGS. 2 and 3 may be performed one after the other in any sequence. Suitably the axis (13) with pulp product (1) fixed to its end is moved from the position as shown in FIG. 2 to the position as shown in FIG. 3 or from the position shown in FIG. 3 to the position shown in FIG. 2 wherein the spraying guns and supply conduits are not moved.

Alternatively, the spraying guns (20) and (21) illustrated in FIG. 3) may be moved towards the paper pulp product (1) as positioned as shown in FIG. 2) to spray all the outer surfaces of the paper pulp product (1) simultaneously. The reverse is also possible wherein the spraying guns (17,18) as illustrated in FIG. 2) are moved towards the paper pulp product (1) as positioned in FIG. 3). It is also understood that all surfaces may be sprayed simultaneously. Further the orientation of the rotating axis (13) may be any other orientation than the illustrated horizontal orientation. A suitable other orientation is vertical.

FIG. 4 shows a mould (26) having a mould part (27) having a surface (27a) shaped to receive the inner wall surface (28) of a cup shaped starting pulp product (29) and a mould part (30) having a surface (31) shaped to receive the outer wall surface (32) of the pulp product (29). Mould part (27) and mould part (30) provided with pulp product (29) are spaced away as will be the position when the mould part (27) is lowered into mould part (30). When the two mould parts (27) and (30) are pressed together the pulp product (29) will be sandwiched in between. Mould part (27) is provided with channels (33) fluidly connecting a source of liquid wax and the wall surface (27a) and the inner wall surface (28) of the cup shaped pulp product (29). When liquid wax is supplied to these channels the surface (28) will be provided with the liquid wax. Mould part (30) is also provided with channels (34) fluidly connecting a source of liquid wax and the wall surface (31) and the outer wall surface (32) of the cup shaped pulp product (29). When liquid wax is supplied to these channels the surface (32) will be provided with the liquid wax to form a coating of wax once the temperature is reduced to below the melting temperature of the wax.

The invention will be illustrated by the following non-limiting experiments.

### EXAMPLE 1

A planting apparatus as shown in FIG. 1 was made from waste carton fibre pulp. The outer wall surface of the outer wall, the inner wall surface of the annular compartment and the outer wall surface of the inner wall is sprayed with liquid wax, which was a mixture of refined hydrocarbon waxes, having a melting point of 85°. The temperature of the liquid wax as provided to the spraying gun was 120° C. The amount of wax sprayed on the surface of the planting apparatus was about 100 g/m². The temperature was allowed to decrease to ambient temperatures such that the wax solidified. The planting apparatus thus obtained was placed in a mould at 125° C. for 15 seconds and wherein the two mould halves were pressed together at a moderate pressure of 0.25 MPa. The product was released from the mould and the temperature was reduced to ambient temperatures such that the wax solidified.

### EXAMPLE 2

Example 1 was repeated except that the obtained waxed planting apparatus obtained in Example 1 was placed in a mould at 125° C. for 15 seconds and wherein the two mould halves were pressed together at a pressure of 1.5 MPa. The product was released from the mould and the temperature was reduced to ambient temperatures such that the wax solidified.

### EXAMPLE 3

From the planting apparatuses as obtained in Examples 1-2 a circular cut out was obtained and fixed at the lower open end of a 5 cm diameter tube. The tubes were filed with a layer of 100 cm water and the decrease in water level was measured over time. The results are listed in Table 1. For comparison also a cut out of the starting planting apparatus was obtained, ie not treated with wax. This cut out was also fixed to a tube and filled with 100 cm water.

TABLE 1

| | | Example 1 | |
|---|---|---|---|
| | | (with wax | Example 2 |
| Product - subjected | Standard material | and hot | (with wax and hot |
| to 100 cm water | (no wax, with hot | press (low | press (high |
| column pressure | press) | pressure) | pressure) |
| Water level after 10 | 56.0 | 100.0 | 100.0 |
| minutes (cm) | | | |
| Water level after 60 | <10 | 92.0 | 99.9 |
| minutes (cm) | | | |
| Water level after | | 24.0 | 91.5 |
| 1440 minutes (cm) | | | |

The results in Table 1 show that when the pulp product is prepared according to the process of the invention a more water resistant product is obtained.

1. Process to prepare a three-dimensional shaped biodegradable pulp product by
(b) pressing a 3D product made of biodegradable pulp which product is coated with a water-resistant compound having a melting temperature of above 40° C. in a mould at a temperature above the melting temperature of the water-resistant compound, and
(c) releasing the product from the mould and reducing the temperature to below the melting temperature of the water-resistant compound.

2. Process according to claim 1, wherein the water-resistant compound is a wax having a melting temperature of between 60° C. and 120° C.

3. Process according to claim 2, wherein the wax is a paraffinic wax and/or microwax.

4. Process according to claim 1, wherein the 3D product which is coated with a water-resistant compound is obtained in a step (a) in which step the water-resistant compound is sprayed on the surface of a starting three-dimensional shaped biodegradable pulp product.

5. Process according to claim 4, wherein the starting three-dimensional shaped biodegradable pulp product is a container comprising an annular compartment with a downwardly tapering outer wall of circular cross section and an upwardly tapering inner wall defining a central open channel through which a symmetry axis runs, wherein the annular compartment is closed at its lower end and open at its upper end.

6. Process according to claim 5, wherein in step (a) the outer wall surface of the outer wall, the inner wall surface of the annular compartment and the outer wall surface of the upwardly tapering inner wall is sprayed with the water-resistant compound while the three-dimensional shaped biodegradable pulp product rotates around the symmetry axis.

7. Process according to claim 6, wherein less or no water resistant compound is sprayed on the upwardly tapering inner wall as compared to the amount of water resistant compound sprayed on the downwardly tapering outer wall in terms of the amount of wax per surface area resulting in that the upwardly tapering inner wall is more water permeable than the downwardly tapering outer wall.

8. Process according to claim 5, wherein a different water-resistant compound is sprayed on the upwardly tapering inner wall as compared to the water-resistant compound sprayed on the downwardly tapering outer wall resulting in that the upwardly tapering inner wall is more water permeable than the downwardly tapering outer wall.

9. Process according to claim 1, wherein the 3D product and coated with a water-resistant compound is obtained by a process step wherein a three-dimensional biodegradable pulp product is present between at least two parts of a mould and wherein the water-resistant compound is supplied as a liquid to the surface of the starting three-dimensional biodegradable pulp product via channels as present in the mould parts which channels fluidly connect a source of the liquid water-resistant compound and the surface of the starting three-dimensional biodegradable pulp product.

10. Process according to claim 9, wherein the 3D product is a container comprising an annular compartment with a downwardly tapering outer wall of circular cross section and an upwardly tapering inner wall defining a central open channel through which a symmetry axis runs, wherein the annular compartment is closed at its lower end and open at its upper end.

11. Process according to claim 10, wherein less or no water resistant compound is supplied to the surface of the upwardly tapering inner wall as compared to the amount of water resistant compound supplied to the surface of the downwardly tapering outer wall in terms of the amount of wax per surface area resulting in that the upwardly tapering inner wall is more water permeable than the downwardly tapering outer wall.

12. Process according to claim 10, wherein a different water-resistant compound is supplied to the surface of the upwardly tapering inner wall as compared to the water-resistant compound supplied to the surface of the downwardly tapering outer wall resulting in that the upwardly tapering inner wall is more water permeable than the downwardly tapering outer wall.

13. A planting aid product comprising
a container comprising an annular compartment for water composed of a biodegradable pulp with a downwardly tapering outer wall and an upwardly tapering inner wall defining a central open channel, where in use a plant is positioned, wherein the annular compartment is closed at its lower end and open at its upper end,
wherein a circular lid closes the upper open end of the annular compartment and wherein the lid has a central opening which opening aligns with the central open channel of the container, and
wherein the downwardly tapering outer wall and an upwardly tapering inner wall are coated by a water-resistant compound.

14. A planting aid product according to claim 13, wherein the upwardly tapering inner wall is more water permeable than the downwardly tapering outer wall, wherein the downwardly tapering outer wall is coated with a water-resistant compound and the upwardly tapering inner wall may be coated with a water-resistant compound and wherein the difference in water permeability of the inner and outer wall is at least in part a result of a difference in the content, quality and/or position of the water-resistant compound as coated on the inner and outer walls.

15. A planting aid product according to claim 13, wherein the water-resistant compound is a wax having a melting temperature of between 60° C. and 120° C.

16. A planting aid product according to claim 15, wherein the wax is a paraffinic wax and/or microwax.

17. A planting aid product according to claim 13, wherein the water permeability of the upwardly tapering inner wall is at least 0.05 litre/day as measured 5 days after the annular compartment is filled water to 95% of its vertical height.

18. A planting aid product according to claim 13, wherein no wick is present to transport water from the annular compartment to the plant in the central channel.

19. A planting aid product comprising:
a container comprising an annular compartment for water composed of a biodegradable pulp with a downwardly tapering outer wall and an upwardly tapering inner wall defining a central open channel, where in use a plant is positioned, wherein the annular compartment is closed at its lower end and open at its upper end; and
wherein a circular lid closes the upper open end of the annular compartment and wherein the lid has a central opening which opening aligns with the central open channel of the container;
obtained by a process comprising:
(a) spraying a water-resistant compound having a melting temperature of above 40° C. to coat a surface of a starting three-dimensional shaped biodegradable pulp product;
(b) pressing the starting three-dimensional shaped biodegradable pulp product in a mould at a temperature above the melting temperature of the water-resistant compound; and
(c) releasing the product from the mould and reducing the temperature to below the melting temperature of the water-resistant compound.

20. The planting aid product of claim 19, wherein the downwardly tapering outer wall is sprayed with a first water-resistant compound, and the upwardly tapering inner wall is sprayed with a different second water-resistant compound, resulting in that the upwardly tapering inner wall is more water permeable than the downwardly tapering outer wall.
